(19) United States
(12) Patent Application Publication
(10) Pub. No.: US 2025/0291914 A1
(43) Pub. Date: Sep. 18, 2025

(54) MALWARE SEVERITY FRAMEWORK BASED ON METADATA AND MACHINE LEARNING

(71) Applicant: Cyber adAPT, Dallas, TX (US)

(72) Inventors: Polyxeni Mountrouidou, Charleston, SC (US); Samuel Stover, Gettysburg, PA (US)

(21) Appl. No.: 18/604,381

(22) Filed: Mar. 13, 2024

(51) Int. Cl. G06F 21/56

(52) U.S. Cl. CPC G06F 21/56; G06F 2221/033

(57) ABSTRACT

A malware detection prioritization method is disclosed. The method includes receiving, by a user interface of an electronic device, a user input. The method further includes selecting, by a selector of the electronic device, characteristics of malware applications based on the user input and one or more malware severity criteria associated with at least one of proliferation or an operation impact. The method further includes converting, by a transformer of the electronic device, the characteristics of the malware applications into numerical values. The method further includes processing, by a machine learning model of the electronic device, the numerical values and the user input to generate an indication of one or more highest severity malware applications among the malware applications. The method further includes monitoring, by a detection engine of the electronic device, for the one or more highest severity malware applications.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Malware is a general term commonly used to refer to malicious software (e.g., including a variety of hostile, intrusive, and/or otherwise unwanted software). Example uses of malware include disrupting computer and/or computer network operations, stealing proprietary information (e.g., confidential information, such as identity, financial, and/or intellectual property related information), gaining access to private/proprietary computer systems and/or computer networks, and/or manipulating or destroying data, digital systems, and even hardware. Malware can be in the form of codes, scripts, executables, active content, and/or other software. Unfortunately, as techniques are developed to help detect and mitigate malware, malware attacks are on the rise due to technological evolution. For instance, as organizations and/or users are becoming increasingly connected and interconnected, and transactions are increasingly performed online, opportunities open for malware to easily creep into computer systems and/or user devices. Accordingly, there is a need for continued improvements in techniques for malware detection and mitigation.

### SUMMARY

In an embodiment, a malware detection prioritization method is disclosed. The method includes receiving, by a user interface of an electronic device, a user input comprising at least one of user-specific information, device-specific information, or location-specific information. The method further includes selecting, by a malware characteristic selector stored in non-transitory memory of the electronic device and executable by a processor of the electronic device, characteristics of a plurality of malware applications based on the user input and one or more malware severity criteria associated with at least one of proliferation or an operation impact. The method further includes converting, a malware characteristics transformer stored in the non-transitory memory of the electronic device and executable by the processor of the electronic device the characteristics of the plurality of malware applications into numerical values indicative of the characteristics. The method further includes processing, by a machine learning model stored in the non-transitory memory of the electronic device and executable by the processor of the electronic device, the numerical values indicative of the characteristics and the user input to generate an indication of one or more highest severity malware applications among the plurality of malware applications. The method further includes monitoring, by a malware detection application stored in the non-transitory memory of the electronic device and executable by the processor of the electronic device, for the one or more highest severity malware applications.

In another embodiment, a malware severity level determination method is disclosed. The method includes receiving, by a malware characteristics transformer stored in non-transitory memory of a computer system and executable by a processor of the computer system, malware metadata comprising characteristics associated with a plurality of malware applications, wherein each of the characteristics is associated with at least one of proliferation or an operation impact of a respective one of the plurality of malware applications. The method further includes converting, by the malware characteristics transformer, the characteristics of the plurality of malware applications into numerical values indicative of severity of the characteristics. The method further includes adjusting, by a weight adjuster stored in the non-transitory memory of the computer system and executable by the processor of the computer system, a plurality of weights, each corresponding a respective one of the characteristics. The method further includes processing, by a machine learning model stored in the non-transitory memory of the computer system and executable by the processor of the computer system, the characteristics of the plurality of malware applications and the plurality of weights to generate a plurality of malware severity indices, each indicative of a severity level of a respective one of the plurality of malware applications. The method further includes generating, by a malware severity report generator stored in the non-transitory memory of the computer system and executable by the processor of the computer system, based on the plurality of malware severity indices, a malware severity report comprising an indication of one or more highest severity malware applications among the plurality of malware applications.

In yet another embodiment, a malware detection prioritization method is disclosed. The method includes converting, by a malware characteristics transformer stored in non-transitory memory of a computer system and executable by a processor of the computer system, characteristics of a plurality of malware applications into numerical values indicative of the characteristics, where each of the characteristics is associated with at least one of proliferation or an operation impact of a respective one of the plurality of malware applications. The method further includes adjusting, by a weight adjuster stored in the non-transitory memory of the computer system and executable by the processor of the computer system, a plurality of weights, each corresponding to a respective one of the characteristics. The method further includes processing, by a machine learning model stored in the non-transitory memory of the computer system and executable by the processor of the computer system, the numerical values indicative of the characteristics and the plurality of weights to generate a plurality of malware severity indices, each indicative of a severity level of a respective one of the plurality of malware applications. The method further includes prioritizing, by a malware detection engine, detection of at least a first malware application of the plurality of malware applications over a second malware application of the plurality of malware applications.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a malware detection system with a malware severity determination according to an embodiment of the disclosure.

FIG. 2 is a block diagram illustrating a malware severity framework according to an embodiment of the disclosure.

FIG. 3 is a block diagram illustrating a malware characteristic transformation method according to an embodiment of the disclosure.

FIG. 4 illustrates an example malware characteristic to malware severity criteria mapping according to an embodiment of the disclosure.

FIG. 5 is a block diagram of an electronic device that implements malware detection based on a malware severity determination according to an embodiment of the disclosure.

FIG. 6 is a block diagram of an electronic device that implements malware detection based on a malware severity determination according to an embodiment of the disclosure.

FIG. 7 is a flow chart of a malware detection prioritization method based on a malware severity determination according to an embodiment of the disclosure.

FIG. 8 is a flow chart of a malware detection prioritization method based on malware severity determination according to an embodiment of the disclosure.

FIG. 9 is a flow chart of a malware severity determination method according to an embodiment of the disclosure.

FIG. 10 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Companies are inundated with malware. For example, a company may receive millions of alarms generated a day associated with suspected malware, but the company may only have resources to review and/or address a small fraction of the alarms in a given day. While there are software products or services that will determine whether a piece of code is malware or not, this determination tends to be a basic binary answer (i.e., yes this is malware or no this is not malware). For instance, a trojan may be indicated as malware and adware may be indicated as non-malware. While having knowledge of whether suspected codes are malware or non-malware can allow companies to focus on addressing those that are identified as malware, there can still be thousands or millions of pieces of detected malware to be addressed in a given day. As such, it may be desirable to have knowledge on how to filter the alarms and determine which of those detected malware may be more harmful (e.g., to a company's operations, systems, networks, and/or security) than others so that companies may allocate resources appropriately and efficiently to handle (e.g., quarantine or delete) the more harmful malware prior to handling less harmful malware.

Currently, there is a lack of available software products that can provide more insightful or contextual information related to impacts (or harmfulness) of malware to companies other than indicating whether suspected software is malware or non-malware discussed above. As such, any malware severity determination is often performed retroactively in the aftermath of a piece of malware such as by determining how many machines were affected by the piece of malware and/or how much damage was done by the piece of malware. Further, as discussed above, technological evolution allowing users and companies to be more connected, techniques for identifying, detecting, and/or mitigating malware effectively and/or efficiently for computer systems and devices (e.g., mobile phones, Internet of Things (IoT) devices, smart TV, smart appliances, etc.) are becoming increasingly important. Furthermore, different companies and/or different users may have different concerns related to a particular piece of malware. For instance, malware rendering a device or system inoperable may be more important to one company or individual while malware being able to activate a microphone or access bank credentials may be more important to a different company or individual. Thus, it may be challenging to provide a measure of harmfulness or severity for a particular piece of malware that is applicable to any company or individual.

To overcome the shortcomings in existing malware detection and/or mitigation solutions, the present disclosure provides techniques to proactively determine severity of malware in a quantitative, objective way using machine learning (ML) and quantitative metrics. For instance, a malware severity framework may be executed on a general-purpose computer (e.g., a personal computer, a server, etc.), an electronic device (e.g., a mobile phone, a smart phone, a smart television, an IoT device, etc.), or a cloud computing platform. The malware severity framework determines the severity of malware based on at least two metrics (or criteria): proliferation and an operation impact of the malware. The malware severity framework determines proliferation and an operation impact of malware based on metadata (e.g., features, characteristics, or attributes) associated with the malware functionality.

Proliferation pertains to the ability of the malware to spread (e.g., how many machines the malware can infect, how deep into a system or device the malware can infect, and/or how fast the malware can spread). For example, metadata associated with the malware may include an operating system (OS) version the malware may run on. Based on that information, a range of software versions, a range of hardware versions, and/or how hardware versions affected by the malware can be determined. Proliferation may also pertain to the attractiveness of the malware to an end user. For example, if the malware is associated with a popular icon (e.g., a Microsoft® Word icon, etc.), the malware is associated with a particular type of application (e.g., a productivity application, battery optimizer application, bandwidth optimizer application, banking application, etc.), or if the malware is associated with an application that is lightweight and easy to download, the malware may be more attractive to an end user and therefore be more prolific.

Operation impact pertains to the ability of the malware to degrade or damage operations of a host (e.g., how much the malware affects the host's intended operations). For example, metadata associated with the malware may include information about application security that indicates which parts of the host (e.g., the computer system or device) the malware is allowed to interact with (i.e., device permissions), and/or how much the malware will modify or degrade the performance of the host (e.g., a minor performance impact, involving data and/or program deletion or encryption of data, turning the device inoperable, etc.).

The malware severity framework converts the proliferation and the operation impact into numerical values (e.g., quantitative measures) that can be processed by an ML model trained to determine severity of malware in a quantitative manner and/or a severity ranking among multiple different pieces of malware. For instance, the ML model may output an indication of whether one malware is more severe than another malware, a list of predefined number of most severe malwares among the different pieces of malware, or a ranking for each piece of malware in a list of malware pieces. In this way, malware detection software can utilize the severity and/or ranking information to prioritize detection and/or mitigation of a more severe malware over a less severe malware.

According to an embodiment of the present disclosure, the malware severity framework may include a malware characteristics transformer, a weight adjuster, a malware severity ML model, and a malware severity report generator stored in non-transitory memory of a computer system and executable by one or more processor(s) of the computer system. The malware characteristics transformer may convert characteristics of a plurality of malware applications into numerical values indicative of the characteristics, or more specifically indicative of the severity of the characteristics. The plurality of malware applications may be in various forms such as code, scripts, executables, active contents, and/or other software. The plurality of malware applications may be of various application types (e.g., a productivity application, battery optimizer application, bandwidth optimizer application, banking application, etc.). The malware characteristics transformer may determine the severity of a particular characteristic of a particular malware application based on criteria such as proliferation and/or an operation impact of the characteristic as discussed above.

Examples of characteristics related to proliferation for a particular malware application may include, but are not limited to, a software version (e.g., a maximum OS version, a minimum OS version, a range of OS versions) and/or a hardware version (e.g., a maximum hardware version, a minimum hardware version, a range of hardware versions) on which the malware application may run, an application size of the malware application, an application type of the malware application, and/or an icon of the malware application. Examples of characteristics related to an operation impact for a particular malware application may include, but are not limited to, accesses (e.g., a read and/or a write) to a component (e.g., camera, microphone, sensors, etc.), data (e.g., photo library, contact list, etc.), and/or memory of the computer system and/or a performance impact to the computer system, where the accesses can be in the form of API calls, requested permissions, and/or codes of the malware applications.

In an embodiment, as part of transforming the characteristics of the plurality of malware applications into numerical values, the malware characteristics transformer may encode each characteristic of each of the plurality of malware applications into encoded values based on the proliferation or the operation impact of the respective malware application with respect to the characteristic and embed (or combine) the encoded values (encoded from the characteristics of the plurality of malware applications) into sequences of numerical values (e.g., a matrix of numerical values). The encoding may include assigning each characteristic of each malware application with a severity level indicator selected from a plurality of severity level indicators (e.g., a high-severity indicator, a medium-severity indicator, and a low-severity indicator, or indicators with more granular severity levels). The assignment may be based on a determination (or evaluation) of the proliferation or the operation impact of the particular malware application with respect to the particular characteristic. In embodiments, a particular characteristic of a particular malware application may include a plurality of elements, each associated with a component of the computer system or an operation of the malware application. As an example, a characteristic related to permission(s) requested by a particular malware application may include a permission to access a microphone, a permission to access a camera, and a permission to read and/or write to a certain memory. As another example, a characteristic related to API calls triggered by a particular malware may include a memory read operation, a memory write operation, and an access to a component (e.g., a microphone) of the computer system. In such embodiments, the encoding may include assigning a severity indicator to each element of the plurality of elements and counting, for the particular characteristic, the number of occurrences for each severity level indicators, where the encoded values may include the number of occurrences for respective ones of the severity level indicators.

As discussed above, different companies or individual users may have different concerns related to malware. To address these different concerns, weights may be applied to the criteria obtained from the characteristics. These weights enable adjustability depending on a specific object or context (e.g., user context, usage context, or business context). For example, malware rendering the device inoperable may be more important to one company or individual while malware being able to activate a microphone or access bank credentials may be more important to a different company or individual. To that end, the weight adjuster may adjust a plurality of weights, each corresponding to a respective one of the characteristics. The adjustment may be based on a user context, a usage context, or a business context. Examples of user context may include, but are not limited to, a user location (e.g., in a particular area, city, country, continent, etc.), a user language (e.g., English, Chinese, Korean, etc.). Examples of usage context may include, but are not limited to, whether the system or device is a smart phone, a smart TV, a smart home appliance, an IoT device, or a video conferencing system, and whether the system is for personal use school use, or business use. Examples of business context may include, but are not limited to, banking, medical, legal, education, and enterprise. In other embodiments, the weights for the different characteristics can be set by a user or an analyst.

To determine the severity of the plurality of malware applications, the numerical values (indicative of the severity of the characteristics of the plurality of malware applications) and the corresponding weights may be provided as input to the malware severity ML model (a trained ML model). The malware severity ML model may process the numerical values and the corresponding weights to output a severity determination. The severity determination may be provided in terms of a spectrum of severity to enable a company, an organization, an analyst, or an individual to understand how severe or harmful a malware application is. In one example, the spectrum of severity for the malware applications may be provided in terms of a predefined number of the most severe malware application(s) (e.g., a top x (10, 25, etc.) among the plurality of malware applications). In another example, the spectrum of severity for the malware applications may be provided in terms of high severity, medium severity, or low severity for each malware application or some other ranking mechanisms. In an embodiment, the malware severity ML model may output a plurality of severity indices, each indicating a severity level of a respective one of the plurality of malware applications. In an embodiment, the malware severity ML model output may be used to update (e.g., ML model weights of) the malware severity ML model and/or update rules used for performing the encoding and/or the embedding at the malware characteristics transformer.

In an embodiment, the malware severity ML model may be trained using labelled data (a training dataset). The labelled data may include characteristics of malware samples (e.g., millions of malware samples), corresponding weights for the characteristics, and corresponding severity (e.g., ground truths, for example, determined by an expert) of the malware samples. To that end, the malware severity framework may further include a malware severity determination training component to update or adjust the malware severity ML model (e.g., ML model weights of the ML model) based on a comparison of a severity determination output by the malware severity ML model for a given input (e.g., characteristics and weights) against the labelled data. The malware severity ML model may be a deterministic model trained to provide an optimized minimum-maximum solution, for example, to maximize maximum desirable criteria (e.g., number of hardware parts the malware can access) and minimize minimum desirable criteria (e.g., software version allowed to install the malware, the higher the version, the less the malware can spread). A deterministic model may refer to a model that provides the same output in every run for a given input.

The severity determination output by the malware severity ML model can be used for prioritizing malware detection and/or mitigation. In an embodiment, the malware severity report generator may generate a report based on the severity determination. For example, the report may indicate a list of predefined number of highest severity malware applications among the plurality of malware applications. In an embodiment, the malware severity report generator may provide the report to a malware detection engine, which may be executed on the same computer system as the malware severity framework or on a different computer system. The malware detection engine may prioritize malware detection based on the report. For instance, the report may indicate that a first malware application of the plurality of malware application is more severe than a second malware application of the plurality of malware applications, and thus the malware detection engine may prioritize detection of the first malware application over the second malware application. The malware detection engine may also prioritize mitigation (e.g., quarantining or deletion) of the first malware application over the second malware application.

In an embodiment, the malware severity report generator may include additional information associated with the severity determination, for example, a justification for the severity determination, in the report. For instance, the additional information may indicate which of the characteristic(s) led to the severity determination provided. As an example, the additional information may indicate that a particular malware application 130 has a high severity because the malware application 130 may infect any phone made by a certain maker irrespective of what OS software version may be running. As another example, the additional information may indicate that a particular malware application 130 has a high severity because the particular malware application 130 may infect or delete certain data (e.g., banking data). The malware detection engine may perform malware detection and/or mitigation further based on the additional information.

While the malware severity framework discussed above is in the context of determining malware severity on a computer system, the malware severity framework may be implemented on any suitable electronic device (e.g., mobile phones, IoT devices, smart TV, smart appliances, etc.). In one embodiment, the electronic device may utilize the same malware severity framework as discussed above. In another embodiment, the electronic device may further include a user interface and a malware characteristics selector in addition to a malware characteristics transformer, a weight adjusted, and a malware severity ML model. The electronic device may receive, via the user interface, a user input related to user-specific information (e.g., languages supported by applications on the electronic device), device-specific information (e.g., software and/or hardware information), and/or location-specific information (e.g., a city, a country in which the electronic device is being used). The malware characteristics selector may select, from metadata associated with a plurality of malware applications, characteristics of the plurality of malware applications based on the user input (e.g., the received user-specific information, device-specific information, and/or location-specific information). The malware characteristics transformer may convert the selected characteristics into numerical values, the weight adjuster may determine weights for the selected characteristics based on the user input, and the malware severity ML model may generate a malware severity determination for the plurality of malware applications using similar mechanisms as discussed above.

In yet another embodiment, the electronic device may not include a weight adjuster. To that end, the electronic device may include an ML model (which may be referred to as a weighted malware severity ML model) trained to generate malware severity rankings (a severity determination) by processing the user input (e.g., the user-specific information, device-specific information, and/or location-specific information) and the numerical values (indicative of the characteristics). The severity determination may be in various forms as discussed above.

According to another embodiment of the present disclosure, the malware severity framework discussed herein can be implemented on a computer system or a cloud platform, and the output of the malware severity framework (e.g., the malware severity report) can be utilized by a company to drive malware detection software and/or algorithm development (e.g., to build detection and/or mitigation software for more severe malware). For example, if the malware severity framework indicates malware A is the most severe malware among malware A, B, C, D, the company may allocate more resources (e.g., efforts and/or funding) for developing tool(s) for detecting and mitigating malware A than the other malware B, C, and D. Alternatively, the company may not allocate any resources for developing tool(s) for the other malware B, C, and/or D.

Providing quantitative severity measures for malware in the form of severity levels and/or a severity ranking enables companies to prioritize resources for detection and/or handling of more severe malware over less severe malware. Utilizing criteria such as proliferation and operation impact for assessing the severity of a piece of malware allows for a quantitative and objective measure of malware severity. Providing adjustable weights for each malware characteristic provides companies or users with flexibility to set the weights according to their desired objective for protection against malware.

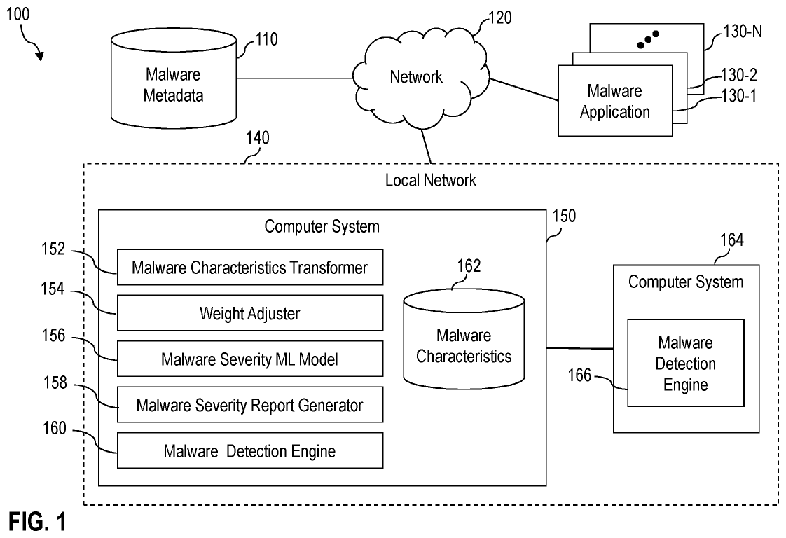

Turning to FIG. 1, a malware detection system 100 with a malware severity determination is described. The malware detection system 100 may include malware metadata 110, a network 120, N number of malware applications 130 (individually shown as 130-1, 130-2, . . . , 130-N, where N may be any suitable integer value), a computer system 150, and a computer system 164. The network 120 promotes communication between the components of the malware detection system 100. The network 120 may be any communication network including a public data network (PDN), a public switched telephone network (PSTN), a private network, and/or a combination.

The malware applications 130 may be of various malware types, for example, including but not limited to, viruses, worms, trojans, ransomware, adware, and/or spyware. The malware applications 130 may be of various application types, for example, including but not limited to, a productivity application, a battery optimizer application, a bandwidth optimizer application, and/or a banking application. The malware applications 130 may be in various forms, for example, including but not limited to, codes, scripts, executables, active contents, and/or other software. The malware applications 130 may be originated from various providers or authors. The malware applications 130 may infect computer systems and/or devices that are connected to the network 120.

The malware metadata 110 may include characteristics associated with the malware applications 130. In an example, the malware applications 130 are known malware and the malware metadata 110 may be generated based on analysis of the code and/or behaviors of the malware applications 130. In an example, the malware metadata 110 may be a database that can be downloaded by companies or users for developing malware detection and/or mitigation related algorithms and/or software tools. In an example, the characteristics for a particular malware application 130 (e.g., the malware application 130-1) may include a maximum OS version, a minimum OS version, an OS version range, and/or hardware permissions, such as using the camera, read/write memory operations, keystroke logging, etc. Additionally or alternatively, the characteristics may include an indication of manufacturers and/or models of hardware (e.g., an iPhone®, an Android® phone, a Pixel® phone, a web camera, a router, a Personal Computer (PC), etc.) on which the malware application 130 may run. Additionally or alternatively, the characteristics may include a maximum software version, a minimum software version, and/or a software version range of a particular software that may be infected by the malware application. Additionally or alternatively, the characteristics may include an application size of the malware application 130. Additionally or alternatively, the characteristics may include an application type of the malware application 130 (e.g., a productivity application, battery optimizer application, bandwidth optimizer application, banking application, etc.). Additionally or alternatively, the characteristics may include an icon of the malware application 130. Additionally or alternatively, the characteristics may include an application security and/or an application code that may be impacted by the malware application 130. Additionally or alternatively, the characteristics may include APIs called by the malware application 130. Additionally or alternatively, the characteristics may include, permissions (e.g., access to certain component(s) or device(s) connected to a computer system or host on which the malware is executed) requested by the malware application 130. Additionally or alternatively, the characteristics may include a provider of the malware application 130. Additionally or alternatively, the characteristics may include, activities of the malware application 130 (e.g., accessing the Internet or a certain network, obtaining and/or manipulating user or system location information, accessing memory of the computer system, accessing a microphone of the computer system, make a phone call, etc.). Additionally or alternatively, the characteristics may include a manifest file of the malware application 130 (e.g., an AndroidManifest.xml file, required to provide essential information about the application in order to be hosted on Google Play®).

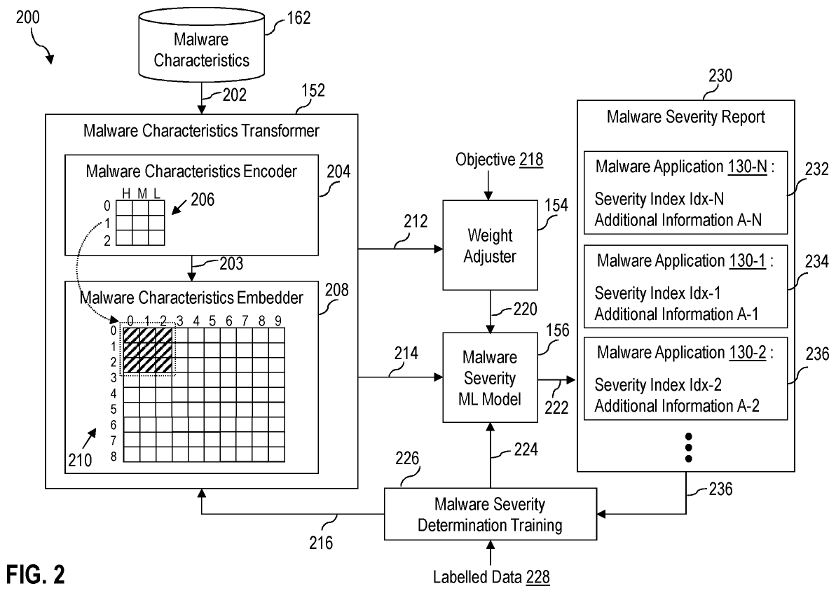

The computer system 150 may include a malware characteristics transformer 152, a weight adjuster 154, a malware severity ML model 156, a malware severity report generator 158, and a malware detection engine 160 stored in non-transitory memory of the computer system 150 and executed by one or more processor(s) of the computer system 150. The malware characteristics transformer 152, the weight adjuster 154, the malware severity ML model 156, and the malware severity report generator 158 may be part of a malware severity framework (e.g., the malware severity framework 200 of FIG. 2). The computer system 150 may further include malware characteristics 162 stored in memory of the computer system 150. The malware characteristics 162 may be associated with the malware applications 130. For instance, the malware characteristics 162 may be obtained from the malware metadata 110.

The malware severity framework may determine the severity of the malware applications 130 based on at least two metrics (or criteria): proliferation and an operation impact of the malware applications 130. In an embodiment, the malware characteristics 162 may be selected or identified from the malware metadata 110 based on the malware characteristics 162 being associated with proliferation or an operation impact. In an embodiment, the malware severity framework may determine (evaluate, assess) proliferation and/or an operation impact of each malware application 130 based on the malware characteristics 162 that are associated with the respective malware application 130.

The malware characteristics transformer 152 may convert the malware characteristics 162 of the malware applications 130 into numerical values indicative of the severity of the respective malware characteristics 162. More specifically, each of the malware characteristics 162 may be associated with proliferation and/or an operation impact of a respective malware application 130, and the numerical values may be indicative of the severity of the characteristics 162 in terms of proliferation and/or an operation impact.

The weight adjuster 154 may determine or adjust a plurality of weights, each corresponding to a respective one of the malware characteristics 162. As discussed above, different companies or individual users may have different concerns related to malware. For example, malware rendering the device inoperable may be more important to one company or individual while malware being able to activate a microphone or access bank credentials may be more important to a different company or individual. Thus, the adjustment may be based on a specific objective, for example, related to a user context, a usage context, or a business context. Examples of user context may include, but are not limited to, a user location (e.g., in a particular area, city, country, continent, etc.), a user language (e.g., English, Chinese, Korean, etc.). Examples of usage context may include, but are not limited to, whether the system or device is a smart phone, a smart TV, a smart home appliance, an IoT device, or a video conferencing system, and whether the system is for personal use, school use, or business use. Examples of business context may include, but are not limited to, banking, medical, legal, education, and enterprise. In an embodiment, the adjustment or turning of the weights may be performed by a user or an analyst. Stated differently, the weight adjuster 154 provides a set of knobs, each corresponding to one of the malware characteristics 162, and a user or an analyst may tune the knobs according to a desired objective. For example, a higher weight (a large value) may be assigned to a malware characteristic 162 that is of a higher importance and a lower weight (a smaller value) may be assigned to a malware characteristic 162 of a lower importance.

The malware severity ML model 156 may process the numerical values indicative of the severity of the characteristics 162 and the corresponding weights to output a severity determination for the malware applications 130. The severity determination output may be in a variety of forms. The severity determination may generally provide an indication of whether one malware application 130 is more severe (or harmful) than another malware application rather than a simple binary classification of whether a malware application 130 is malware or non-malware. In one example, the output of the malware severity ML model 156 may include a list of predefined number of the most severe malware applications 130 (e.g., a top x (10, 25, etc.) among the N malware applications 130. In some examples, the output may further provide the list of most severe malware applications 130 ordered according to respective rankings. In another example, the output of the malware severity ML model 156 may include an indication of high severity, medium severity, or low severity, or an indication at any other suitable severity level granularity, for each malware application 130. In another example, the output of the malware severity ML model 156 may include a severity ranking for each of the malware applications 130. For instance, the number of malware applications 130 is 50 (i.e., N=50), and the output may indicate a ranking between 1 to 50 for each malware application 130. In general, the malware severity ML model 156 may provide the severity ranking information in any suitable format.

The malware severity report generator 158 may generate a report based on the output of the malware severity ML model 156. The operations and interactions of the malware characteristics transformer 152, the weight adjuster 154, the malware severity ML model 156, and the malware severity report generator 158 will be discussed more fully below with reference to FIG. 2.

In an embodiment, the malware severity report generator 158 may provide the report (including the severity determination for the malware applications 130) to the malware detection engine 160. The malware detection engine 160 may prioritize malware detection based on the report. As an example, the report may indicate that one malware application 130 is more severe (harmful) than another malware application 130. For instance, the report may indicate that the malware application 130-N is more severe than the malware application 130-1, and thus the malware detection engine 160 may prioritize detection of the malware application 130-N over the malware application 130-1. In another example, the report may indicate a number (e.g., a predefined number) of the most severe malware application(s) 130 among the N number of malware applications 130. For instance, the report may indicate that the malware applications 130-1 and 130-N are the most severe (harmful) malware applications among the N number of malware applications 130, and thus the malware detection engine 160 may prioritize detection and/or mitigation for the malware applications 130-1 and 130-N over the other malware applications 130. In some instances, the malware detection engine 160 may also detect a malware application 130 (e.g., the malware application 130-2) outside of the most severe malware list, but may postpone the handling (e.g., quarantining or deletion) of the malware application 130-2 to a later time. In other instances, the malware detection engine 160 may ignore malware application 130 outside of the most severe malware list.

In an embodiment, the computer system 150 and 164 may be part of a local network 140 (e.g., an enterprise network, a home network, a school network, etc.). In general, the local network 140 may include any suitable number of computer systems or devices (e.g., 2, 3, 4, 5, 6, 7, 8, 9, 10 or more). The malware severity framework may be implemented on one computer system (e.g., the computer system 150 as shown) of the local network 140 and the severity determination (output by the malware severity framework) can be provided to other computer system(s) in the local network 140 so that the other computer system(s) may also utilize the severity determination to prioritize malware detection and/or mitigation. In the illustrated example of FIG. 1, the computer system 164 may also include a malware detection engine 166 stored in non-transitory memory of the computer system 164 and executed by one or more processor(s) of the computer system 164. The malware detection engine 166 may perform substantially similar operations as the malware detection engine 160 discussed above, for example, prioritizing malware detection and/or mitigation based on the severity determination provided by the computer system 150.

FIG. 1 is merely an example of components of a malware detection system, and variations are contemplated to be within the scope of the present disclosure. In embodiments, the malware detection system may include other components not illustrated in FIG. 1. In embodiments, the malware detection system may not include every component illustrated in FIG. 1. In embodiments, the components and connections may be implemented with different connections than those illustrated in FIG. 1. Such and other embodiments are contemplated to be within the scope of the present disclosure.

Turning now to FIG. 2, a malware severity framework 200 is described. The malware severity framework 200 may be implemented by the malware characteristics transformer 152, the weight adjuster 154, the malware severity ML model 156, and the malware severity report generator 158 of FIG. 1.

At 202, the malware characteristics 162 for the malware applications 130 are provided to the malware characteristics transformer 152. The malware characteristics transformer 152 may include a malware characteristics encoder 204 and a malware characteristics embedder 208. The malware characteristics transformer 152 may convert (or transform) the malware characteristics 162 into numerical values indicative of the severity of the malware characteristics 162.

As part of the conversion, the malware characteristics encoder 204 may encode each malware characteristic 162 (e.g., a certain API call, a certain permission, etc.) of a particular malware application 130 (e.g., the malware application 130-1) into encoded values 206. For instance, the malware characteristics encoder 204 may assign the malware characteristic 162 with a severity level indicator selected from a plurality of severity level indicators. In the illustrated example of FIG. 2, the severity level indicators may include a high-severity indicator (denoted as “H”), a medium-severity indicator (denoted as “M”), and a low-severity indicator (denoted as “L”). The assignment may be based on a determination or assessment of the proliferation and/or the operation impact of the malware application 130 with respect to the particular malware characteristic 162. The malware characteristics encoder 204 may generate encoded values 206 for a malware application 130 in the form of a table or matrix, where each row may correspond to a specific malware characteristic of the malware application 130 and each column may correspond to a respective one of the severity level indicators (shown by “H”, “M”, and “L”). As an example, a first malware characteristic 162 of the malware application 130 may be assigned with a high severity, a second malware characteristic 162 of the malware application 130 may be assigned with a low severity, and a third malware characteristic 162 of the malware application 130 may be assigned with a medium severity. Thus, the encoded values 206 may include a value of 1 in the first row and the first column (for the first characteristic 162 with the high severity), a value of 1 in the second row and the third column (for the second characteristic 162 with the low severity), and a value of 1 in the third row and the second column (for the third characteristic 162 with the medium severity). While the encoded values 206 illustrated in FIG. 2 include three columns and three rows, in general, encoded values 206 for a given malware application 130 may include any suitable number of columns (e.g., 2, 3, 4, 5 or more), for example, depending on a granularity of the severity level indicators and any suitable number of rows (e.g., 1, 2, 3, 4, 5, 6, 7, 8, 9 or more), for example, depending on the number of malware characteristics for the malware application 130. Further, the encoded values 206 may be arranged alternatively to represent malware characteristics in columns and severity levels in rows. In general, the encoded values 206 may include malware characteristics and corresponding severity arranged in any suitable ways.

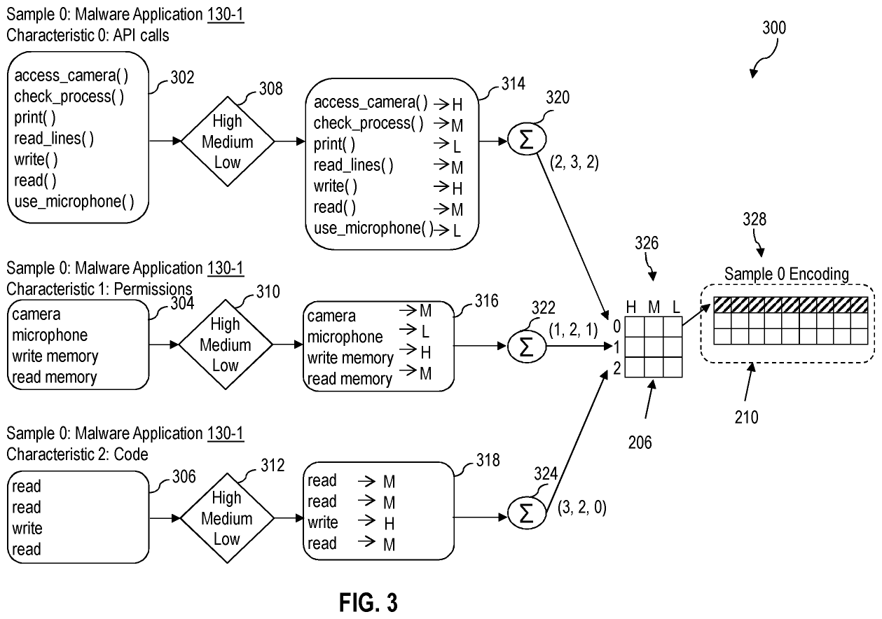

In some instances, a particular malware characteristic 162 may include a plurality of elements, each associated with a component of the computer system 150 or an operation of the malware application 130. For instance, a malware characteristic 162 related to permissions requested by a particular malware application 130 may include a permission to access a microphone, a permission to access a camera, and a permission to read and/or write to a certain memory. As will be discussed more fully below with reference to FIG. 3, in such instances, the malware characteristics encoder 204 may assign a severity indicator to each element of the plurality of elements based on the proliferation and/or the operation impact of the element. The malware characteristics encoder 204 may determine the number of occurrences (e.g., a count value) for each severity level indicator and include the count value in a respective location of the table or matrix of encoded values 206.

At 203, the malware characteristics encoder 204 may provide the encoded values 206 for each malware application 130 to the malware characteristics embedder 208. The malware characteristics embedder 208 may embed the encoded values 206 for each of the malware applications 130 into numerical values 210 (e.g., embeddings). In general, the numerical values 210 may be arranged in any suitable formats, for example, vectors or sequences of numerical values, or a table or matrix of numerical values. In some instances, the process of embedding the encoded values into the numerical values 210 may be referred to as vectorization. Further, the malware characteristics embedder 208 may embed (combine, arrange, or order) the encoded values 206 (encoded from each malware applications 130) in any suitable way. In the illustrated example of FIG. 2, the encoded values 206 for a particular malware application 130 is embedded into columns 0-2 and rows 0-2 shown by the patterned boxes in the top left portion of the numerical values 210. In general, the dimension of the table or matrix of numerical values 210 may be dependent on the number of characteristics for all N malware applications 130 under evaluation and the granularity of severity level indicators used by the malware characteristics encoder 204.

At 212, the malware characteristics transformer 152 may provide indications of the malware characteristics 162 processed by the malware characteristics transformer 152 to the weight adjuster 154. The malware characteristics transformer 152 may process a common malware characteristic 162 (e.g., a characteristic related to permissions) for multiple malware applications 130 (e.g., the malware applications 130-1 and 130-N). Based on the processing, the malware characteristics transformer 152 may output an indication of the malware characteristic 162 for each malware application 130. Thus, for N number of malware applications 130, the malware characteristics transformer 152 may output N indications of the malware characteristics, one per malware application 130. Stated differently, the malware characteristics transformer 152 may process multiple instances of a particular malware characteristic 162 (e.g., related to API calls), where each instance may be for a different malware application 130, and may provide N indications of the particular malware characteristic 162, where each indication corresponds to one of the malware applications 130, to the weight adjuster 154.

For example, the malware application 130-1 may have malware characteristics 162 A, B, and C, the malware application 130-2 may have malware characteristics 162 A, B, and D, and the malware application 130-N may have malware characteristics 162 C, D, and E. That is, malware characteristics 162 A and B are common to the malware applications 130-1 and 130-2, malware characteristics 162 C is common to the malware applications 130-1 and 130-N, and malware characteristics 162 D is common to the malware applications 130-2 and 130-N. In such an example, the malware characteristics transformer 152 may provide an indication, for each malware characteristic 162 and for each malware application 130 (e.g., in a vector form), to the weight adjuster 154. For example, for the malware application 130-1, the malware characteristics transformer 152 may output a vector [1, 1, 1, 0, 0] to indicate that characteristics 162 A, B, and C exist, but the characteristics 162 D and E are absent. Conversely, for the malware application 130-2, the malware characteristics transformer 152 may output a vector [1, 1, 0, 1, 0] to indicate that malware characteristics 162 A, B, and D exist, but the characteristics 162 C and E are absent. While this example illustrates the output of the malware characteristics transformer 154 being an indication of whether a particular malware characteristic 162 is present or absent (e.g., a binary indication) for a particular malware application 130, in another embodiment, an indication output by the malware characteristics transformer 152 may indicate a severity of a particular characteristics for a particular malware application 130 as will be discussed more fully below with reference to FIG. 3.

The weight adjuster 154 may adjust a plurality of weights, each corresponding to a respective one of the malware characteristics 162 received from the malware characteristics transformer 152. Referring to the example discussed above, the weight adjuster 154 may receive the malware characteristics 162 in vector form from the malware characteristics transformer 152 and may determine or adjust a set of weights, e.g., represented by W1, W2, W3, W4, and W5 for respective malware characteristics 162. The weights may be the same for all malware applications 130. In an example, the weights (e.g., W1, W2, W3, W4, and W5) may be a value between 0 and 1 and all the weights may add up to 1. The adjustment may be based on a particular objective 218. The objective 218 may include contextual information, for example, including but not limited to, a user context, a usage context, and/or a business context. Examples of user context may include, but are not limited to, a user location (e.g., in a particular area, city, country, continent, etc.), a user language (e.g., English, Chinese, Korean, etc.). Examples of usage context may include, but are not limited to, whether the system or device is a smart phone, a smart TV, a smart home appliance, an IoT device, or a video conferencing system, and whether the system is for personal use, school use, or business use. Examples of business context may include, but are not limited to, banking, medical, legal, education, and enterprise. As an example, the objective 218 may include a business context where application security may be of the highest importance, and thus the weight adjuster 154 may assign a highest weight for a malware characteristic 162 corresponding to application security.

At 220, the weight adjuster 154 may provide the determined or adjusted weights to the malware severity ML model 156. At 214, the malware characteristics transformer 152 may provide the computed numerical values 210 (indicative of the presence and/or the severity of the malware characteristics 162 of the malware applications 130) to the malware severity ML model 156.

The malware severity ML model 156 may process the numerical values 210 indicative of the malware characteristics 162 and corresponding weights to generate a severity determination. At 222, the malware severity ML model 156 may output the severity determination for report generation. In an embodiment, the malware severity ML model 156 may output a plurality of severity level indices, each corresponding to a respective one of the malware applications 130. For instance, the output may indicate a severity index, denoted as Idx-N, for the malware application 130-N, indicate a severity index, denoted as Idx-1, for the malware application 130-1, and indicate a severity index, denoted as Idx-2, for the malware application 130-2. In one embodiment, each of the severity indices Idx-N, Idx-1, and Idx-2 may be one of a high severity (H), medium severity (M), or low severity (L), or at any other severity granularity. In another embodiment, each of the severity indices Idx-N, Idx-1, and Idx-2 may be a severity ranking. For instance, the severity index I-A may indicate a value of 1, the severity index I-B may indicate a value of 2, and the severity index I-C may indicate a value of 3, where a higher severity index value may correspond to a higher severity or vice versa and the output may further be arranged in the order of ranking. In yet another embodiment, each of the severity indices I-A, I-B, or I-C may be a severity score, for example, with a score value between 0 to 100, where a higher score value may correspond to a higher severity or vice versa. In some examples, the malware severity report 230 can also provide the severity determination result for the malware applications 130 in the form of a graph.

A malware severity report 230 may be generated based on the output of the malware severity ML model 156. As shown, the malware severity report 230 may include an indication 232 for the malware application 130-N, an indication 234 for the malware application 130-1, and an indication 236 for the malware application 130-2, and so on. In an embodiment, the indication 232, 234, 236 may be in an increasing order of severity. For instance, the malware applications 130-N, 130-2, and 130-1 may be the top 3 most severe malware among the N number of malware applications 130. In an embodiment, the malware severity report 230 may provide additional information associated with the malware applications 130. As shown, the indication 232 may include additional information A-N for the malware application 130-N, the indication 234 may include additional information A-1 for the malware application 130-1, and the indication 236 may include additional information A-2 for the malware application 130-2. The additional information may include an indication of reason(s) or a justification for the malware severity determination. For instance, the additional information may include an indication of particular malware characteristic(s) 162 that led to the corresponding severity index. As an example, the additional information A-N for the malware application 130-N may indicate that an access to banking data requested by the malware application 130-N had led the malware application 130-N to be the most severe malware among the malware applications 130, the additional information A-1 for the malware application 130-1 may indicate that an access to a contact list requested by the malware application 130-N had led the malware application 130-1 to be the next most severe malware among the malware applications 130, and so on.

As discussed above, the malware severity ML model 156 may be a deterministic model trained to optimize a minimum-maximum solution. In an embodiment, the malware severity ML model 156 may be trained using labelled data 228 (e.g., a training dataset). The labelled data 228 may include malware characteristics (e.g., similar to the malware characteristics 162) of malware samples (e.g., millions of malware samples similar to the malware applications 130), corresponding weights for the characteristics, and corresponding severities (e.g., ground truths) of the malware samples. For instance, the labelled data 228 may include data tuples, each including an indication of characteristics of a malware application 130, corresponding weights for the characteristics, and a severity index for the malware application 130 (e.g., ground truths). In an example, the malware severity ML model 156 may be a neural network including neurons activated by ML model weights (internal to the ML model).

As further shown in FIG. 2, the malware severity framework may further include a malware severity determination training component 226 to train and update the malware severity ML model 156 (e.g., adjust the ML model weights). In an example, the ML model weights of the malware severity ML model 156 may be initialized to random values and trained to activate the neurons such that the malware severity ML model 156 may output malware severity rankings that follow the labels (e.g., the ground truths). To that end, the ML model weights may be updated based on a comparison of a severity determination output by the malware severity ML model 156 for a given input (e.g., characteristics and weights) against the labelled data 228. The comparison may include computing an error measure for an output generated by the malware severity ML model 156. Based on the error measure, the malware severity ML model 156 may be updated. During a training phase of the malware severity ML model 156, the process of feeding malware characteristics and corresponding weights to the malware severity ML model 156 to generate a severity determination output, comparing the output against the labelled data 228, and updating the malware severity ML model 156 and the ML model weights based on the comparison may be iterated until the error measure is sufficiently small (e.g., satisfies a certain threshold). When the error measure is satisfactory, the malware severity ML model 156 is a trained model and can be deployed in the computer system 150 for operation.

In an embodiment, reinforced learning can be applied during an operational phase where the trained malware severity ML model 156 is utilized for severity determination. For instance, at 236, the output (e.g., the severity indices for the respective malware applications 130) of the malware severity ML model 156 may be provided to the malware severity determination training component 226. At 224, the malware severity determination training component 226 may continue to update the malware severity ML model 156 based on a comparison of the severity determination output by the malware severity ML model 156 and the labelled data 228. Additionally, at 216, the malware severity determination training component 226 may also update rules that are used to encode and/or embed the malware characteristics 162 at the malware characteristics transformer 152. As an example, the rules may include rules for determining whether a certain malware characteristic 162 has a high severity, medium severity, or low severity in terms of proliferation and/or an operation impact, for example, based on a number of machines or computer systems infected meeting a certain threshold and/or a level of performance degradation at an infected computer system. As another example, the rules may include a specific threshold of malware application size to be used for determining the severity of a malware application, and this threshold may be updated by the training component 226.

FIG. 2 is merely an example of components of a malware severity framework, and variations are contemplated to be within the scope of the present disclosure. In embodiments, the malware severity framework may include other components not illustrated in FIG. 2. In embodiments, the malware severity framework may not include every component illustrated in FIG. 2. In embodiments, the components and connections may be implemented with different connections than those illustrated in FIG. 2. Such and other embodiments are contemplated to be within the scope of the present disclosure.

Turning to FIG. 3, a malware characteristic transformation method 300 is described. The malware characteristic transformation method 300 may be implemented by the malware characteristics transformer 152 discussed above with reference to FIGS. 1 and 2. As shown in FIG. 3, a malware sample (e.g., the malware application 130-1) may include characteristics 302, 304 and 306 (e.g., obtained from the malware characteristics 162). The characteristic 302 may be related to API calls triggered by the malware application 130-1, the characteristic 304 may be related to permissions requested by the malware application 130-1, and the characteristic 306 may be related to codes of the malware application 130-1. In general, the malware characteristics transformer 152 may evaluate any suitable number of malware characteristics 162 for a malware sample.

As further shown in FIG. 3, each of the characteristics 302, 304, 306 may include a plurality of elements. For instance, the characteristic 302 may include various API calls including access_camera( ), check_process( ), print( ), read_lines( ), write( ), read( ), and use microphone( ). The characteristic 304 may include permissions for access to a camera of the computer system 150, access to a microphone of the computer system 150, a write access to memory of the computer system 150, a read access to memory of the computer system 150. The characteristic 306 may include three read operations and one write operation (e.g., to certain components and/or memory of the computer system 150).

As similarly discussed above, the malware characteristics encoder 204 may assign to each element of each characteristic 302, 304, 306 of the malware application 130-1 a severity level indicator selected from a plurality of severity level indicators. In the illustrated example of FIG. 3, the plurality of severity indicators may include a high severity indicator (denoted as “H”), a medium severity indicator (denoted as “M”), and a low severity indicator (denoted as “L”). In general, the severity indicators may have any suitable granularity (e.g., including more than 3 severity levels). The determination may be in terms of proliferation and/or an operation impact of the corresponding element. In some instances, the determination may be performed by domain experts. As shown, at 308, the malware characteristics encoder 204 may assign to each element of the characteristic 302 one of the H, M, or L severity indicators as shown by 314. Similarly, at 310, the malware characteristics encoder 204 may assign to each element of the characteristic 304 one of the H, M, or L severity indicators as shown by 316. At 312, the malware characteristics encoder 204 may assign to each element of the characteristic 306 one of the H, M, or L severity indicators as shown by 318.

At 320, the malware characteristics encoder 204 may count (or add) the number of occurrences for each of the severity level indicators assigned to the characteristic 302. As shown, there are 2 counts of high severity level indicators, 3 counts of medium severity level indicators, and 2 counts of low severity level indicators (e.g., shown by (2, 3, 2)) for the characteristic 302. Similarly, at 322, the malware characteristics encoder 204 may count (or add) the number of occurrences for each of the severity level indicators assigned to the characteristic 304. At 324, the malware characteristics encoder 204 may count (or add) the number of occurrences for each of the severity level indicators assigned to the characteristic 306. In an example, if a particular malware characteristic 162 does not exist for a particular malware application 130, the number of occurrences for all severity level indicators for that particular malware characteristic 162 and malware application 130 may be set to 0.

At 326, the malware characteristics encoder 204 may generate the encoded values 206 by including the number of occurrences for each severity level indicators and for each characteristic 302, 304, and 306 into the table or matrix of encoded values 206 accordingly. For instance, the first row of the encoded values 206 may include the values 2, 3, 2 (corresponding to the characteristic 302), the second row of the encoded values 206 may include the values 1, 2, 1 (corresponding to the characteristic 304), and the third row of the encoded values 206 may include the values 3, 2, 0 (corresponding to the characteristic 306).

At 328, the malware characteristics embedder 208 may embed the encoded values 206 (for the malware application 130-1) into the numerical values 210 as discussed above with reference to FIG. 2. The encoded values 206 for the malware application 130-N are embedded into a corresponding portion of the table or matrix of numerical values. For instance, in the table or matrix, each row may correspond to a particular malware application 130, and each column may correspond to a particular severity of a particular malware characteristic 162. Further, the columns may be grouped by malware characteristics 162 and arranged in the order of L, M, H for a respective malware characteristic 162. In the illustrated example of FIG. 3, sample 0 encoded values are embedded at row 0. Generally, the table or matrix of numerical values can be arranged in any suitable order.

Subsequently, the malware characteristics transformer 152 may perform the encoding and embedding for another malware application (e.g., the malware application 130-2, . . . , 130-N) using the same mechanisms. In general, the malware characteristic embedder 208 may embed the encoded values for each malware application 130 into a certain portion of the numerical values 210. The configuration for the embedding may be predetermined and may be aligned with the configuration used for training.

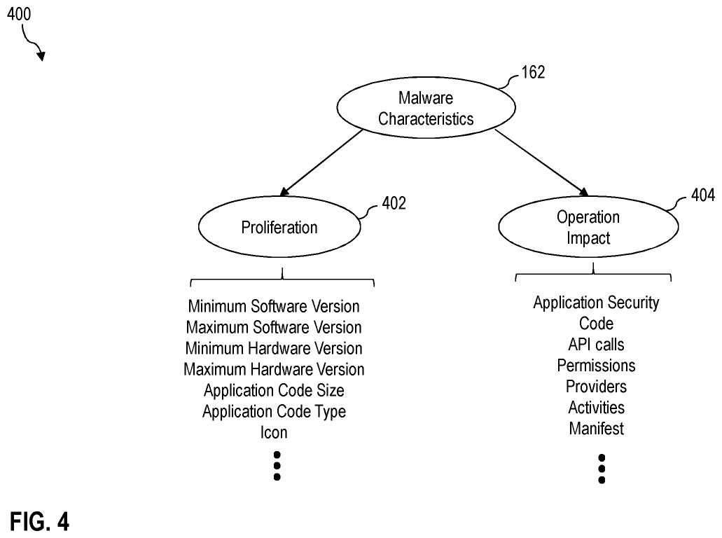

Turning now to FIG. 4, an example malware characteristic to malware severity mapping 400 is described. The malware characteristics 162 may be divided into one category related to proliferation 402 and another category related to an operation impact 404. If a malware characteristic 162 is in the category related to the proliferation 402, the malware characteristics encoder 204 may determine a severity of the malware characteristic 162 (or an element of the malware characteristic 162) based on proliferation caused by the respective malware characteristic 162 (or the respective element). If, however, a malware characteristic 162 is in the category related to the operation impact 404, the malware characteristics encoder 204 may determine a severity of the malware characteristic 162 (or an element of the malware characteristic 162) based on an operation impact caused by the respective malware characteristic 162 (or the respective element). In some examples, a malware characteristic 162 may be related to both the proliferation 402 and the operation impact 404. In such examples, the malware characteristics encoder 204 may determine a severity of the malware characteristic 162 (or an element of the malware characteristic 162) based on the proliferation caused by the malware characteristic 162 and a severity of the malware characteristic 162 operation impact based on the operation impact caused by the malware characteristic 162. For example, the size (e.g., code size or executable size) of a malware application 130 may impact the malware application 130's proliferation and operation impact. With respect to proliferation, a large-size malware sample may be spread less easily. With respect to operation impact, a large-size sample may operate more completely and implement additional malicious behaviors.

As shown in FIG. 4, the malware characteristics 162 that may be evaluated in terms of the proliferation 402 may include a minimum software version, a maximum software version, a minimum hardware version, and/or a maximum hardware version on which a malware application 130 may run, an application code size of the malware application 130, an application code type of the malware application 130, an icon, etc. The minimum and/or maximum software (e.g., OS) versions and/or the minimum and/or maximum hardware versions that the malware application 130 may run on may indicate the number of machines and/or devices that may be impacted by the malware application 130. For instance, devices with a hardware version within a range between the minimum and maximum hardware versions may be susceptible to the malware application 130, while devices with a hardware version outside the range may not be susceptible to the malware application 130. Similarly, devices executing software with a software version within a range between the minimum and maximum software versions may be susceptible to the malware application 130, while devices executing software with a software version outside the range may not be susceptible to the malware application 130. In general, a malware application 130 that can be executed on a larger version range of software or hardware may be more prolific.

The application code size, the application code type, and/or the icon of the malware application 130 may affect the likelihood of an end user downloading the malware application 130, and thus may affect the proliferation of the malware application 130. For instance, a lightweight (e.g., smaller size) malware application 130 may be more likely to be downloaded by end users than a heavyweight (e.g., larger size) malware application 130 because the lightweight malware application 130 may be downloaded faster. A malware application 130 associated with a certain application type that can promote or improve performance, such as a productivity application, a battery optimizer application, a bandwidth optimizer application, etc., may be more likely to be downloaded by end users. A malware application 130 using a popular or existing icon (e.g., Microsoft® Word, etc.) may make the malware application 130 to appear more complete and legitimate, and thus may be more likely to be downloaded by end users.

As further shown in FIG. 4, the malware characteristics 162 that may be evaluated in terms of the operation impact 404 may include an application security impacted by the malware application 130, a code of the malware application 130, API calls triggered by the malware application 130, permissions requested by the malware application 130, a provider of the malware application 130, activities of the malware application 130, a manifest of the malware application 130, etc. For instance, information about application security may indicate which parts and/or components of the computer system 150 the malware application 130 may interact with. Information about the code and the API calls of the malware application 130 may indicate the extent of data and/or components of the computer system 150 that the malware application 130 may modify and/or the extent of performance of the computer system 150 that the malware application 130 may degrade. Information about the permissions may indicate components (e.g., camera, microphone, photo library, contact list, etc.) or memory of the computer system 150 that the malware application 130 may access. In some cases, similar malware may be provided by different providers and certain providers may cause more damage or disruption than others, and thus the provider information of the malware application 130 can provide an indication of operation impact. Information about the activities (e.g., accessing the Internet or a certain network, obtaining and/or manipulating user or system location information, accessing memory of the computer system, accessing a microphone of the computer system, making a phone call, etc.) may indicate how the malware application 130 may disrupt the computer system 150. Information about manifest files may indicate how the malware application 130 may disrupt system(s), OS, and/or application(s) that interact with and/or utilize the manifest files.

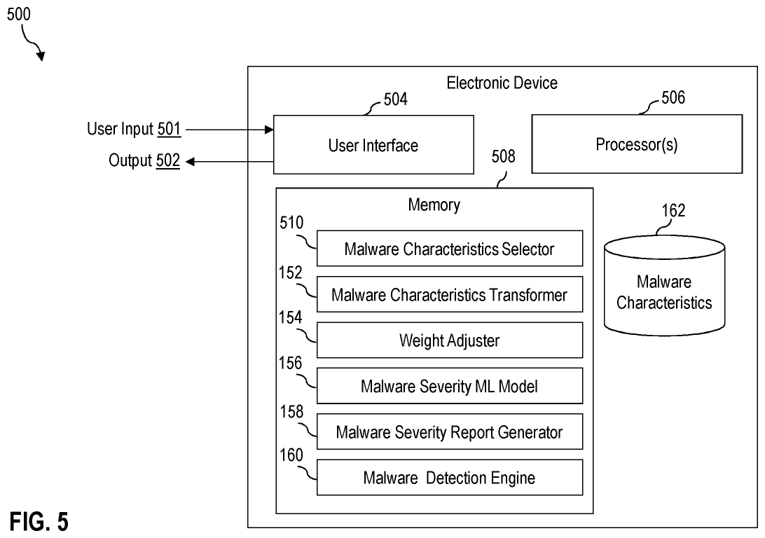

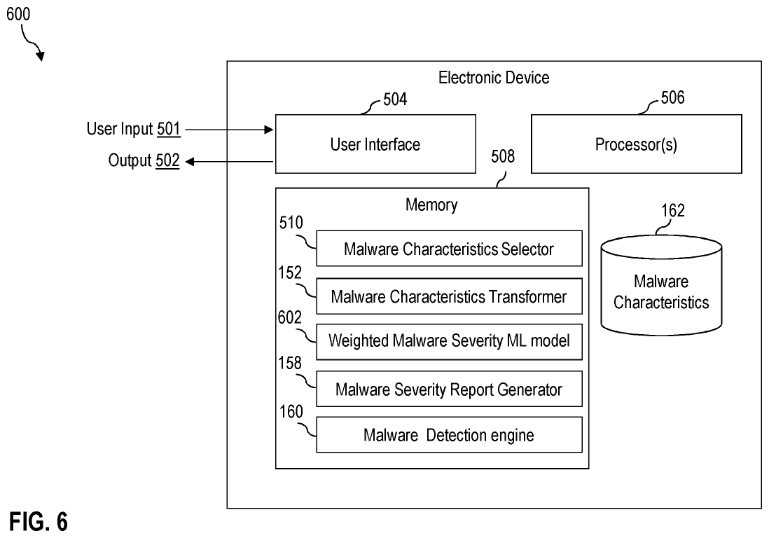

While FIGS. 1-4 are discussed in the context of malware severity determination implemented on the computer system 150, the malware severity determination can be implemented on any suitable electronic device (e.g., mobile phones, IoT devices, tablets, laptops, smart TV, smart appliances, etc.). In one embodiment, an electronic device may implement the same malware severity framework 200 as discussed above. In other embodiments, a malware severity framework for an electronic device may include other components to facilitate user inputs for malware severity determination as will be discussed below with reference to FIGS. 5-6.

Turning now to FIG. 5, an electronic device 500 is described. The electronic device 500 may be a mobile phone, a tablet, a laptop, an IoT device, a smart TV, a smart appliance, etc. The electronic device 500 may include a user interface 504, one or more processors 506, and memory 508 (e.g., non-transitory memory). The user interface 504 may include touch screen displays, keyboards, keypads, etc., that may accept a user input 501 from an end user and/or display an output 502. The malware severity framework discussed above with reference to FIGS. 1-4 may be implemented on the electronic device 500. As shown, the memory 508 may store a malware characteristics transformer 152, a weight adjuster 154, a malware severity ML model 156, a malware severity report generator 158, a malware detection engine 160, and malware characteristics 162 similar to the computer system 150 of FIG. 1, and an additional malware characteristic selector 510. In some instances, the malware characteristics 162 may be stored in memory separate from the memory 508. The malware characteristic selector 510, the malware characteristics transformer 152, the weight adjuster 154, the malware severity ML model 156, and the malware severity report generator 158 may be executed by the one or more processors 506.

In an embodiment, the electronic device 500 may receive a user input 501 via the user interface 504. The user input 501 may include user-specific information (e.g., languages supported by applications on the electronic device), device-specific information (e.g., software and/or hardware information), and location-specific information (e.g., a city, a country in which the electronic device is being used). The malware characteristics selector 510 may select (e.g., from the malware metadata 110) malware characteristics 162 that are relevant to the user based on the user input 501 (e.g., user-specific information, device-specific information, and/or location-specific information). For instance, based on the user-specific information indicating a supported language (e.g., English, Korean, etc.) on the electronic device 500, the malware characteristics selector 510 may select a certain malware characteristic 162 related to the language supported by a malware application 130. Based on the device-specific information indicating a hardware version and/or a software version of a software that runs on the electronic device 500, the malware characteristics selector 510 may select a certain malware characteristic 162 related to software and/or hardware versions on which a malware application 130 may run. Based on the location information indicating a country in which the electronic device 500 is used, the malware characteristics selector 510 may select a certain malware characteristic 162 related to a country in which the malware application 130 may operate. The selection may be further based on criteria associated with at least one of proliferation or an operation impact, for example, as discussed above with reference to FIG. 4.

The malware characteristics transformer 152 may convert the malware characteristics 162 of the malware applications 130 into numerical values indicative of the severity of the respective malware characteristics 162. The weight adjuster 154 may adjust a plurality of weights, each for a respective one of the selected malware characteristics 162. The weight adjustments may be based on the user input 501. For instance, based on the user-specific information indicating the supported language (e.g., Korean) on the electronic device 500, the weight adjuster 154 may assign a higher weight for a certain malware characteristic 162 related to that language than another malware characteristic 162 related to a different language (e.g., English). Based on the device-specific information indicating a particular hardware version of the electronic device 500 and/or a particular software version of a software that runs on the electronic device 500, the weight adjuster 154 may assign a higher weight for certain malware characteristics 162 related to a software version range including the particular software version and/or related to a hardware version range including the particular hardware version than another malware characteristic related to a software version range excluding the particular software version and/or a hardware version range excluding the particular hardware version. Based on the location information indicating a country (e.g., Korea) in which the electronic device 500 is used, the weight adjuster 154 may assign a higher weight for certain malware characteristics 162 related to malware applications 130 that infect systems and/or devices in that country than another malware characteristic related to another country of operation.

Subsequently, the malware severity ML model 156 may process the selected malware characteristics 162 (output by the malware characteristics selector 510) and the weights (output by the weight adjuster 154) to generate a severity determination for the malware applications 130 as discussed above with reference to FIGS. 1-2. The malware detection engine 160 may prioritize detection and/or mitigation of malware according to the severity determination output by the malware severity ML model 156.

In an embodiment, the electronic device 500 may output, via the user interface 504, a request (an output 502) for the user-specific information, the device-specific information, and/or the location-specific information, and the user input 501 may be received in response to the request. In an embodiment, the request may be in the form of plain English, e.g., questions about the user of the electronic device 500, the location of the user, and/or the device 500, and the user input 501 may be answers to those questions.

Turning now to FIG. 6, an electronic device 600 is described. The electronic device 600 may be substantially similar to the electronic device 500. However, the electronic device 600 may include a weighted malware severity ML model 602 stored in memory 508 instead of a weight adjuster 154 and a malware severity ML model 156. The weighted malware severity ML model 602 may be trained to generate severity indices or rankings for corresponding malware applications 130 by processing the user input 501 (e.g., user-specific information, device-specific information, and/or location-specific information) and the malware characteristics 162.

The weighted malware severity ML model 602 may be trained using substantially similar mechanisms as discussed above with reference to FIG. 2. However, the weighted malware severity ML model 602 may be trained on labelled data (e.g., the labelled data 228) that further includes user-specific information, device-specific information, and/or location-specific information. For instance, the labelled data (used for training the weighted malware severity ML model 602) may include datasets, each including characteristics of a particular malware application 130, at least one of user-specific information, device-specific information, and/or location-specific information, and a severity determination (e.g., ground truths including severity index or ranking labels) for the malware application 130.

The weighted malware severity ML model 602 may be a neural network including neurons activated by ML model weights (internal to the weighted malware severity ML model 602). These ML model weights may be initialized to random values and trained to activate the neurons such that the weighted malware severity ML model 602 may output malware severity rankings that follow the labels (e.g., the ground truths). To that end, the weighted malware severity ML model 602 may be trained to generate ML model weights by processing the labelled data (e.g., including labeled malware applications 130 with labels that correspond to specific rankings). In other words, the weighted malware severity ML model 602 may be trained to discover objective(s) or context for ranking malware severity based on labeled rankings. For instance, the weighted malware severity ML model 602 may be trained using the labelled data including datasets, each including indications of malware characteristics 162 from the malware characteristics transformer 152 and the at least one of the user-specific information, device-specific information, and/or location-specific information. The weighted malware severity ML model 602 may be trained to select ML model weights that minimize the error (loss) between severities or rankings output by the weighted malware severity ML model 602 and the ground truths. After multiple iterations of training, the weighted malware severity ML model 602 may have ML model weights that cause the weighted malware severity ML model 602 to output accurate predictions of rankings based on malware characteristics 162 and user inputs 501 (e.g., the at least one of the user-specific information, device-specific information, and/or location-specific information). Stated differently, the training may include an iterative process that allow the weighted malware severity ML model 602 to learn from the labelled data (e.g., including malware characteristics, user inputs, and malware severity rankings) so that the weighted malware severity ML model 602 may output malware severity rankings matching the ground truths.

FIGS. 5-6 are merely examples of components of electronic devices, and variations are contemplated to be within the scope of the present disclosure. In embodiments, the electronic devices may include other components not illustrated in FIGS. 5-6. In embodiments, the electronic devices may not include every component illustrated in FIGS. 5-6. In embodiments, the components and connections may be implemented with different connections than those illustrated in FIGS. 5-6. Such and other embodiments are contemplated to be within the scope of the present disclosure.

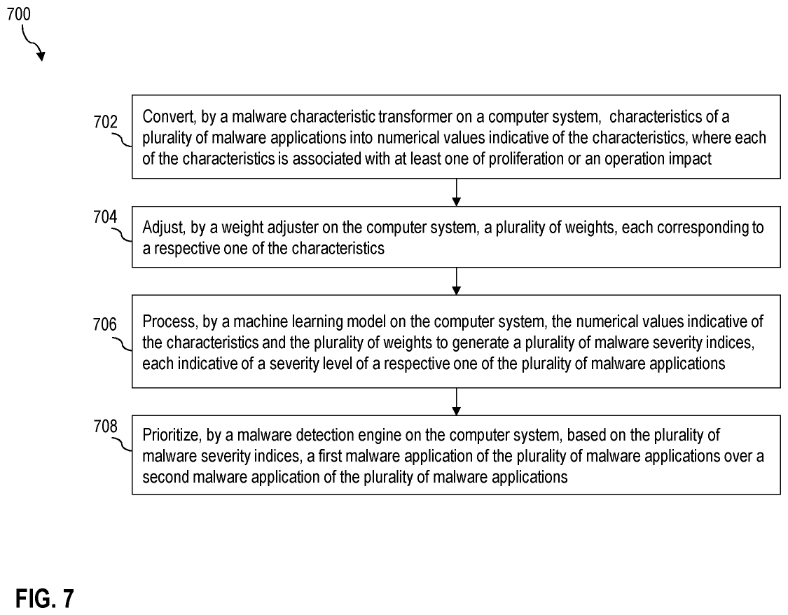

Turning now to FIG. 7, a malware detection prioritization method 700 is described. The method 700 may use similar mechanisms as discussed above with reference to FIGS. 1-6. At block 702, a malware characteristics transformer (e.g., the malware characteristics transformer 152) on a computer system (e.g., the computer system 150), converts characteristics (e.g., the malware characteristics 162) of a plurality of malware applications (e.g., the malware applications 130) into numerical values (e.g., the numerical values 210) indicative of the characteristics. Each of the characteristics is associated with at least one of proliferation or an operation impact of a respective one of the plurality of malware applications, for example, as discussed above with reference to FIG. 4.

In an embodiment, a subset of the characteristics associated with the proliferation of a particular malware application of the plurality of malware applications includes at least one of a software version on which the particular malware application executes, a hardware version of device on which the particular malware application executes, an application type (e.g., a productivity application, battery optimizer application, bandwidth optimizer application, banking application, etc.) of the particular malware application, an application size of the particular malware application, or an icon of the particular malware application. In an embodiment, a subset of the characteristics associated with the operation impact of a particular malware application of the plurality of malware applications is associated with at least one of a component (e.g., camera, microphone, etc.), memory, or data (e.g., photo library, contact list, banking data) of the computer system accessed by the particular malware application.

In an embodiment, as part of converting the characteristics of the plurality of malware applications into the numerical values, the malware characteristics transformer encodes a first characteristic of the characteristics associated with a particular malware application into encoded values (e.g., the encoded values 206) based on a determination of at least one of the proliferation or the operation impact of the particular malware application with respect to the first characteristic and embeds the encoded values into sequences of numerical values to generate the numerical values (e.g., the numerical values 210). In an embodiment, a plurality of elements is associated with the first characteristic of the particular malware application. The plurality of elements is associated with at least one of a component of the computer system or an operation performed by the computer system, and the encoding the first characteristic of the particular malware application into the encoded values includes assigning, for each element of the plurality of elements, a severity level indicator selected from a plurality of severity level indicators (e.g., a high-severity indicator, a medium-severity indicator, and a low-severity indicator, or indicators with different severity granularity) based on a severity of the particular malware application with respect to the respective element. The encoding further includes counting a number of occurrences for each of the plurality of severity level indicators, where the encoded values correspond to the number of occurrences for respective ones of the plurality of severity level indicators, for example, as discussed above with reference to FIG. 3.

At block 704, a weight adjuster (e.g., the weight adjuster 154) on the computer system adjusts a plurality of weights, each corresponding to a respective one of the characteristics. In an embodiment, the adjustment is based on at least one of a user context, a usage context, or a business context.

At block 706, an ML model (e.g., the malware severity ML model 156) on the computer system processes the numerical values indicative of the characteristics and the plurality of weights to generate a plurality of malware severity indices, each indicative of a severity level of a respective one of the plurality of malware applications, for example, as discussed above with reference to FIG. 2. In an embodiment, the plurality of malware severity indices generated by the machine learning model provides a ranking indication of at least a predefined number (e.g., a top 5, top 10, top 20, etc.) of most severe malware applications among the plurality of malware applications.

At block 708, a malware detection engine (e.g., the malware detection engine 160) prioritizes, based on the plurality of malware severity indices, detection of at least a first malware application of the plurality of malware applications over a second malware application of the plurality of malware applications. In some examples, the malware detection engine may be on the same computer system as the malware characteristics transformer, weight adjuster, and the malware severity ML model. In other examples, the malware detection engine may be on a different computer system than the malware characteristics transformer, the weight adjuster, and the malware severity ML model.

In an embodiment, a malware severity determination training component (e.g., the malware severity determination training component 226) on the computer system trains the ML model based on labelled data (e.g., the labelled data 228) comprising specific characteristics of specific malware applications, corresponding weights for the specific characteristics, and corresponding severity determinations for the malware applications. In an embodiment, the malware severity determination training component updates the ML model (e.g., the ML model weights) based on a verification (or comparison) of the plurality of malware severity indices generated by the machine learning model against the labelled data. In an embodiment, the malware severity determination training component further updates rules for converting the characteristics of the plurality of malware applications to the numerical values indicative of the characteristics.

In an embodiment, the malware detection engine further prioritizes, based on the plurality of malware severity indices, mitigation of the first malware application over mitigation of the second malware application. The mitigation may include quarantining the first malware application on the computer system or removing the first malware application from the computer system based on the detection of the first malware application.

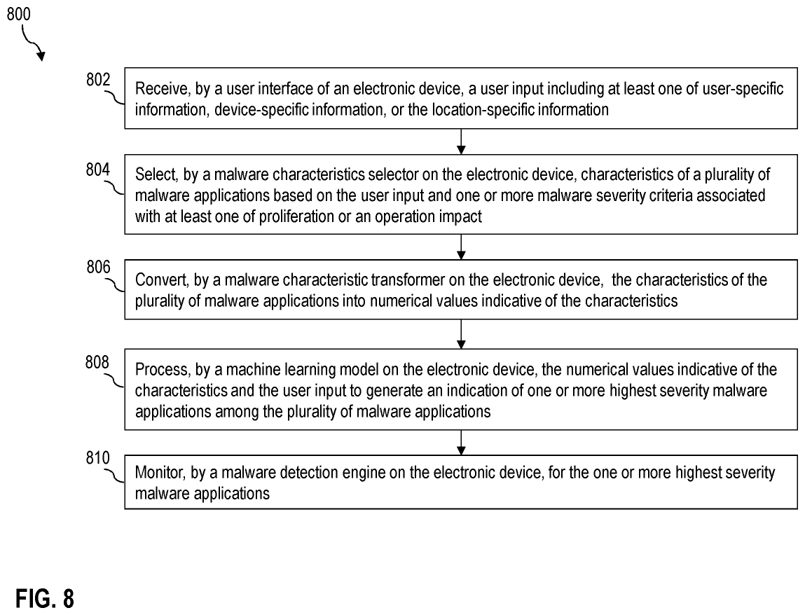

Turning now to FIG. 8, a malware detection prioritization method 800 is described. The method 800 may use similar mechanisms as discussed above with reference to FIGS. 1-6. At block 802, a user interface (e.g., the user interface 504) of an electronic device (e.g., the electronic device 600) receives a user input (e.g., the user input 501) including at least one of user-specific information, device-specific information, or location-specific information.

At block 804, a malware characteristic selector (e.g., the malware characteristics selector 510) on the electronic device selects characteristics (e.g., the malware characteristics 162) of a plurality of malware applications (e.g., the malware applications 130) based on the user input and one or more malware severity criteria associated with at least one of proliferation or an operation impact, as discussed above with reference to FIGS. 5-6.

At block 806, a malware characteristics transformer (e.g., the malware characteristics transformer 152) on the electronic device converts the characteristics of the plurality of malware applications into numerical values (e.g., the numerical values 210) indicative of the characteristics. In an embodiment, the converting includes encoding each of the characteristics into encoded values (e.g., the encoded values 206) based on a determination of at least one of the proliferation or the operation impact of the respective characteristic and embedding the encoded values for each characteristic into a set of vectors, for example, as discussed above with reference to FIGS. 2-3.

At block 808, an ML model (e.g., the weighted malware severity ML model 602) on the electronic device, processes the numerical values indicative of the characteristics and the user input to generate an indication of one or more highest severity malware applications among the plurality of malware applications.

In an embodiment, the ML model is trained on labelled data including datasets, each including characteristics of a particular malware application, at least one of user-specific information, device-specific information, or location-specific information, and a severity determination for the particular malware application, as discussed above with reference to FIG. 6.

At block 810, a malware detection engine (e.g., the malware detection engine 160) on the electronic device, monitors for the one or more highest severity malware applications.

In an embodiment, the user interface further outputs a request for the at least one of the user-specific information, the device-specific information, or the location-specific information, and the user input is received in response to the request.

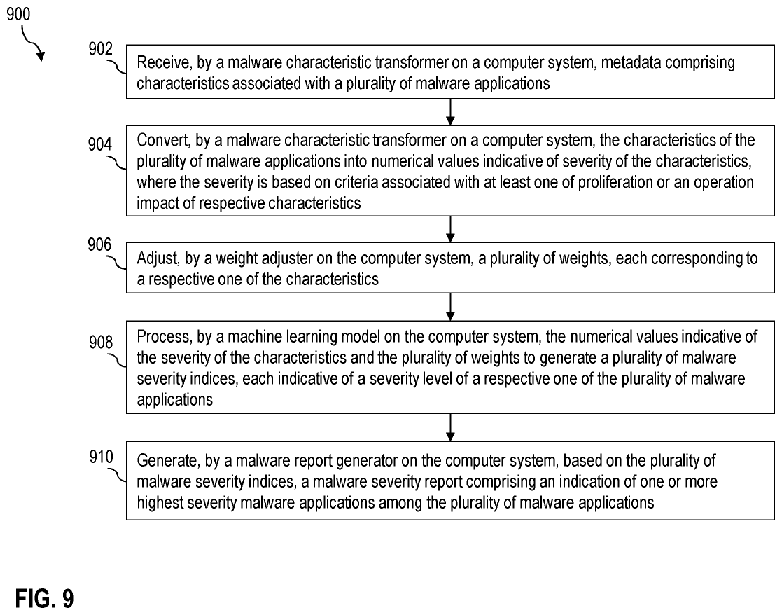

Turning now to FIG. 9, a malware severity level determination method 900 is described. The method 900 may use similar mechanisms as discussed above with reference to FIGS. 1-6. At block 902, a malware characteristics transformer (e.g., the malware characteristics transformer 152) on a computer system (e.g., the computer system 150) receives characteristics (e.g., the malware characteristics 162) associated with a plurality of malware applications (e.g., malware applications 130).

At block 904, the malware characteristics transformer converts the characteristics of the plurality of malware applications into numerical values (e.g., the numerical values 210) indicative of severity of the characteristics, where the severity is based on criteria associated with at least one of proliferation or an operation impact of respective characteristics, for example, as discussed above with reference to FIG. 4.

In an embodiment, as part of converting the characteristics of the plurality of malware applications into the numerical values, the malware characteristics transformer determines at least one of a proliferation severity or an operational impact severity of a first characteristic of the characteristics. The converting further includes encoding, based on the determining, the first characteristic into encoded values (e.g., the encoded values 206) and generating, based on the encoded values, the numerical values indicative of the severity of the characteristics based at least in part on the encoded values, for example, as discussed above with reference to FIGS. 2-3.

At block 906, a weight adjuster (e.g., weight adjuster 154) on the computer system adjusts a plurality of weights, each corresponding to a respective one of the characteristics, for example, based on an objective (e.g., user context, usage context, and/or business context).

At block 908, an ML model on the computer system processes the characteristics of the plurality of malware applications and the plurality of weights to generate a plurality of malware severity indices, each indicative of a severity level of a respective one of the plurality of malware applications.

At block 910, a malware severity report generator (e.g., malware severity report generator 158) on the computer system generates, based on the plurality of malware severity indices, a report (e.g., the malware severity report 230) comprising an indication of one or more highest severity malware applications among the plurality of malware applications. In an embodiment, the report further comprises additional information comprising an indication of one or more specific ones of the characteristics associated with a first malware application of the plurality of malware applications that led to a respective one of the plurality of malware severity indices.

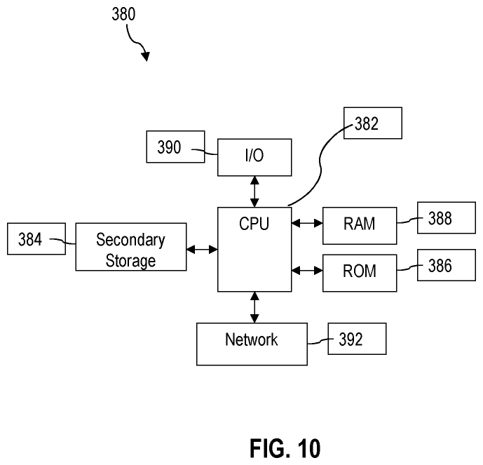

FIG. 10 illustrates a computer system 380 suitable for implementing one or more embodiments disclosed herein. The computer system 380 includes a processor 382 (which may be referred to as a central processor unit or central processing unit (CPU)) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the context of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A malware detection prioritization method comprising:
receiving, by a user interface of an electronic device, a user input comprising at least one of user-specific information, device-specific information, or location-specific information;
selecting, by a malware characteristics selector stored in non-transitory memory of the electronic device and executable by a processor of the electronic device, characteristics of a plurality of malware applications based on the user input and one or more malware severity criteria associated with at least one of proliferation or an operation impact;
converting, a malware characteristics transformer stored in the non-transitory memory of the electronic device and executable by the processor of the electronic device, the characteristics of the plurality of malware applications into numerical values indicative of the characteristics;
processing, by a machine learning model stored in the non-transitory memory of the electronic device and executable by the processor of the electronic device, the numerical values indicative of the characteristics and the user input to generate an indication of one or more highest severity malware applications among the plurality of malware applications; and
monitoring, by a malware detection engine stored in the non-transitory memory of the electronic device and executable by the processor of the electronic device, for the one or more highest severity malware applications.

2. The method of claim 1, further comprising:
outputting, via the user interface, a request for the at least one of the user-specific information, the device-specific information, or the location-specific information.

3. The method of claim 1, wherein the converting the characteristics of the plurality of malware applications into the numerical values indicative of the characteristics comprises:
encoding each of the characteristics into encoded values based on a determination of at least one of the proliferation or the operation impact of the respective characteristic; and
embedding the encoded values for each characteristic into a set of vectors.

4. The method of claim 1, wherein the machine learning model is trained on labelled data comprising datasets, each including at least one of particular user-specific information, particular device-specific information, or particular location-specific information, particular malware characteristics, characteristics of a particular malware application, and a severity determination for particular malware application.

5. A malware severity level determination method comprising:
receiving, by a malware characteristics transformer stored in non-transitory memory of a computer system and executable by a processor of the computer system, malware metadata comprising characteristics associated with a plurality of malware applications, wherein each of the characteristics is associated with at least one of proliferation or an operation impact of a respective one of the plurality of malware applications;
converting, by the malware characteristics transformer, the characteristics of the plurality of malware applications into numerical values indicative of severity of the characteristics;
adjusting, by a weight adjuster stored in the non-transitory memory of the computer system and executable by the processor of the computer system, a plurality of weights, each corresponding to a respective one of the characteristics;
processing, by a machine learning model stored in the non-transitory memory of the computer system and executable by the processor of the computer system, the characteristics of the plurality of malware applications and the plurality of weights to generate a plurality of malware severity indices, each indicative of a severity level of a respective one of the plurality of malware applications; and
generating, by a malware severity report generator stored in the non-transitory memory of the computer system and executable by the processor of the computer system, based on the plurality of malware severity indices, a malware severity report comprising an indication of one or more highest severity malware applications among the plurality of malware applications.

6. The method of claim 5, wherein the converting the characteristics of the plurality of malware applications into the numerical values indicative of the severity of the characteristics comprises:
determining at least one of a proliferation severity or an operational impact severity of a first characteristic of the characteristics;
encoding, based on the determining, the first characteristic into encoded values; and
generating, based on the encoded values, the numerical values indicative of the severity of the characteristics based at least in part on the encoded values.

7. The method of claim 5, wherein the malware severity report further comprises additional information comprising an indication of one or more specific ones of the characteristics associated with a first malware application of the plurality of malware applications that led to a respective one of the plurality of malware severity indices.

8. A malware detection prioritization method comprising:
converting, by a malware characteristics transformer stored in non-transitory memory of a computer system and executable by a processor of the computer system, characteristics of a plurality of malware applications into numerical values indicative of the characteristics, wherein each of the characteristics is associated with at least one of proliferation or an operation impact of a respective one of the plurality of malware applications;
adjusting, by a weight adjuster stored in the non-transitory memory of the computer system and executable by the processor of the computer system, a plurality of weights, each corresponding to a respective one of the characteristics;
processing, by a machine learning model stored in the non-transitory memory of the computer system and executable by the processor of the computer system, the numerical values indicative of the characteristics and the plurality of weights to generate a plurality of malware severity indices, each indicative of a severity level of a respective one of the plurality of malware applications; and
prioritizing, by a malware detection engine based on the plurality of malware severity indices, detection of at least a first malware application of the plurality of malware applications over a second malware application of the plurality of malware applications.

9. The method of claim 8, wherein the converting the characteristics of the plurality of malware applications into the numerical values comprises:
encoding a particular characteristic of the characteristics associated with a particular malware application of the plurality of malware applications into encoded values based on at least one of the proliferation or the operation impact of the particular malware application with respect to the particular characteristic; and
embedding the encoded values into sequences of numerical values to generate the numerical values.

10. The method of claim 9, wherein the encoding the particular characteristic of the particular malware application into the encoded values comprises:
determining the at least one of the proliferation or the operation impact of the particular malware application with respect to the particular characteristic.

11. The method of claim 9, wherein a plurality of elements is associated with the particular characteristic of the particular malware application, wherein the plurality of elements is associated with at least one of a component of the computer system or an operation performed by the computer system, and wherein the encoding the particular characteristic of the first malware application into the encoded values comprises:
assigning, for each element of the plurality of elements, a severity level indicator selected from a plurality of severity level indicators based on a severity of the first malware application with respect to the respective element; and
counting a number of occurrences for each of the plurality of severity level indicators, wherein the encoded values correspond to the number of occurrences for respective ones of the plurality of severity level indicators.

12. The method of claim 8, wherein the adjusting the plurality of weights for the characteristics of the plurality of malware applications is based on at least one of a user context, a usage context, or a business context.

13. The method of claim 8, wherein the plurality of malware severity indices generated by the machine learning model provides a ranking indication of at least a predefined number of most severe malware applications among the plurality of malware applications.

14. The method of claim 8, further comprising:
training, by a malware severity determination training component stored in the non-transitory memory of the computer system and executable by the processor of the computer system, the machine learning model based on labelled data comprising particular characteristics of a particular malware application, corresponding weights, and corresponding severity determination.

15. The method of claim 14, further comprising:
updating, by the malware severity determination training component, the machine learning model based on a verification of the plurality of malware severity indices generated by the machine learning model against the labelled data.

16. The method of claim 8, further comprising:
updating, by a malware severity determination training component stored in the non-transitory memory of the computer system and executable by the processor of the computer system, rules for converting the characteristics of the plurality of malware applications to the numerical values indicative of the characteristics.

17. The method of claim 8, wherein a subset of the characteristics associated with the proliferation of a particular malware application of the plurality of malware applications comprises at least one of:
a software version,
a hardware version,
an application type,
an application size, or
an icon.

18. The method of claim 8, wherein a subset of the characteristics associated with the operation impact of a particular malware application of the plurality of malware applications is associated with access to at least one of a component, memory, or data of the computer system.

19. The method of claim 8, further comprising:
prioritizing, by the malware detection engine based on the plurality of malware severity indices, mitigation of the first malware application over mitigation of the second malware application.

20. The method of claim 19, wherein the mitigation of the first malware application comprises:
quarantining, by the malware detection engine based on the detection of the first malware application, the first malware application on the computer system; or
removing, by the malware detection engine based on the detection of the first malware application, the first malware application from the computer system.
